(19) United States
(12) Patent Application Publication
(10) Pub. No.: US 2007/0295695 A1
(43) Pub. Date: Dec. 27, 2007

(54) EDM wire

(76) Inventor: Dandridge Tomalin, Chagrin Falls, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/473,995

(22) Filed: Jun. 23, 2006

(51) Int. Cl. B23H 1/04; B05D 5/12

(52) U.S. Cl. 219/69.15; 427/118

(57) ABSTRACT

An EDM wire having an outer coating of epsilon phase brass and a process for manufacturing the EDM wire is provided. The process includes coating a copper bearing metallic core with zinc. The zinc coating is then converted to epsilon phase brass by heat treating the wire at a temperature low enough to minimize or eliminate any resulting changes in the mechanical properties of the wire. The coated core wire may be drawn to a finish size prior to heat treatment which will result in a wire with a substantially continuous epsilon phase coating.

### TECHNICAL FIELD

This invention relates to electrical discharge machining (EDM) and specifically to an electrode wire to be used in discharge machining and to a process for manufacturing an EDM electrode wire.

### BACKGROUND

The process of electrical discharge machining (EDM) is well known. In the field of traveling wire EDM, an electrical potential (voltage) is established between a continuously moving EDM wire electrode and an electrically conductive workpiece. The potential is raised to a level at which a discharge is created between the EDM wire electrode and the workpiece. The intense heat generated by the discharge will melt and/or vaporize a portion of both the workpiece and the wire to thereby remove, in a very small increment, a piece of the workpiece. By generating a large number of such discharges a large number of increments are removed from the workpiece whereby the workpiece can be cut very exactly to have a desired planar contour. A dielectric fluid is used to establish the necessary electrical conditions to initiate the discharge and to flush debris from the active machining area.

The residue resulting from the melting and/or vaporization of a small increment (volume) of the surface of both the workpiece and the EDM wire electrode is contained in a gaseous envelope (plasma). The plasma eventually collapses under the pressure of the dielectric fluid. The liquid and the vapor phases created by the melting and/or vaporization of material are quenched by the dielectric fluid to form solid debris. The cutting process therefore involves repeatedly forming a plasma and quenching that plasma. This process will happen sequentially at nanosecond intervals at many spots long the length of the EDM wire.

It is important for flushing to be efficient because, if flushing is inefficient, conductive particles build up in the-gap which can create the potential for electrical arcs. Arcs are very undesirable as they cause the transfer of a large amount of energy which causes large gouges or craters, i.e. metallurgical flaws, to be introduced into the workpiece and the EDM wire electrode. Such flaws in the wire could cause the EDM wire to break catastrophically.

An EDM wire must possess a tensile strength that exceeds a desired threshold value to avoid tensile failure of the wire electrode induced by the preload tension that is applied, and should also possess a high fracture toughness to avoid catastrophic failure induced by the flaws caused by the discharge process. Fracture toughness is a measure of the resistance of a material to flaws which may be introduced into the material and which can potentially grow to the critical size which could cause catastrophic failure of the material. The desired threshold tensile strength for an EDM wire electrode is thought to be in the range 60,000 to 90,000 psi (414 to 620N/mm²).

It is known in the prior art to use an EDM wire electrode with a core composed of a material having a relatively high mechanical strength with a relatively thin metallic coating covering the core and comprising at least 50% of a metal having a low volumetric heat of sublimation such as zinc, cadmium, tin, lead, antimony, bismuth or an alloy thereof. Such a structure is disclosed is U.S. Pat. No. 4,287,404 which discloses a wire having a steel core with a coating of copper or silver which is then plated with a coating of zinc or other suitable metal having a low volumetric heat of sublimation.

It is also known from the prior art, for instance from U.S. Pat. No. 4,686,153, to coat a copper clad steel wire with zinc and thereafter to heat the zinc coated wire to cause inter-diffusion between the copper and zinc to thereby convert the zinc layer into a copper zinc alloy. That patent describes the desirability of a beta phase alloy layer for EDM purposes. The copper zinc has a concentration of zinc of about 45% by weight with the concentration of zinc decreasing radially inward from the outer surface. The average concentration of zinc in the copper zinc layer is less than 50% by weight but not less than 10% by weight. The surface layer therefore includes beta phase copper-zinc alloy material at the outer surface since beta phase copper zinc alloy material has a concentration of zinc ranging between 40%-50% by weight. While this patent recognized that a copper-zinc alloy layer formed by means of a diffusion anneal process could potentially contain epsilon phase (approximately 80% zinc content), gamma phase (approximately 65% zinc content), beta phase (approximately 45% zinc content), and alpha phase (approximately 35% zinc content), the patent asserted that the preferred alloy material is beta phase in the coating.

Others in the prior art, for instance U.S. Pat. No. 5,762,726, recognized that the higher zinc content phases in the copper-zinc system, specifically gamma phase, would be more desirable for EDM wire electrodes, but the inability to cope with the brittleness of these phases limited the commercial feasibility of manufacturing such wire.

This situation changed with the technology disclosed in U.S. Pat. No. 5,945,010. By employing low temperature diffusion anneals, the inventor was able to incorporate brittle gamma phase particles in a coating on various copper containing metallic substrates. However, epsilon phase was found to be too unstable to be incorporated in the resultant high zinc alloy coating, although the potential for brittle epsilon coatings was acknowledged.

Gamma phase coatings are more brittle than beta phase coatings. Conventionally processed, epsilon phase coatings are even more brittle than gamma phase. In addition to the brittleness limitation, epsilon phase is very unstable making it difficult to control the process of converting a zinc coating to epsilon phase.

### SUMMARY

The present invention provides an EDM wire including an outer coating of epsilon phase brass and a process for making the wire.

The invention comprises in one form thereof, an EDM wire with a copper bearing core and a substantially continuous coating of epsilon phase brass.

The invention comprises in another form thereof, an EDM wire with a copper bearing core and a discontinuous continuous coating of epsilon phase brass.

The invention also comprises a process for manufacturing EDM wire with a ductile epsilon phase coating. The process comprises coating a copper bearing core with zinc, and drawing the zinc coated wire to its finish diameter. The zinc coating is then converted to epsilon phase brass by heat treating the wire at a temperature low enough to minimize or eliminate any resulting changes in the mechanical properties of the wire. Optionally, due to the ductility of the epsilon coating, the heat treated wire may be subjected to additional drawing.

The invention, in another form thereof, comprises an EDM wire with a copper bearing core and a substantially continuous coating of porous epsilon phase brass wherein said porous coating has been infiltrated with graphite particles.

### BRIEF DESCRIPTION OF THE DRAWINGS

The features and advantages of this invention will become more apparent and the invention will be better understood by reference to the following description of an embodiment of the invention taken in conjunction with the accompanying figures, wherein:

FIGS. 1 and 2 are cross sectional views of EDM wire constructed in accordance with an embodiment of the present invention; and

FIG. 3 is a scanning electron microscope (SEM) photomicrograph of a cross section of the continuous epsilon phase coating on the wire processed as described in Example 1.

### DETAILED DESCRIPTION

In general, EDM wire will cut more efficiently with a higher zinc content on the eroding surface. For instance a zinc coated brass alloy wire will cut more efficiently than an uncoated brass alloy wire. However, the melting point of the coating is an important factor in determining the efficiency of any given coating's performance. Since unalloyed zinc has a relatively low melting point of 420° C., alloyed coatings with higher melting points (e.g. beta, gamma, or epsilon phase brass alloy coatings) but with lower zinc contents can outperform unalloyed zinc coatings. The higher melting points of these alloys delays them from being removed from the eroding surface by the mechanical and hydraulic forces imposed upon it, and therefore a higher zinc content is available on the surface when it is needed for further erosion. Unfortunately these higher zinc content alloy phases tend to be brittle and therefore are difficult and/or expensive be included on hard drawn EDM wires as continuous coatings.

The brass alloy phases commonly applicable to EDM wires are alpha phase, beta phase, gamma phase, and epsilon phase. Of the brass alloy phases, alpha phase has the highest melting point (approximately 910° C. at its highest commercially feasible zinc content of 35-37 weight percent), beta phase has the next highest melting point (approximately 890° C. in a diffusion annealed coating with a typical 45 weight percent zinc content), gamma phase has the next highest melting point (approximately 800° C. in a diffusion annealed coating with a typical 65 weight percent zinc content), and epsilon phase has the lowest melting point (approximately 550° C. in a diffusion annealed coating with a typical 85 weight percent zinc content).

As the zinc content of these alloy phases increases, the ductility of the phases decreases proportionately and hence the resulting wire becomes more difficult to draw without damaging the coating. The ability to cold draw EDM wire is important because EDM wire needs to have an elevated tensile strength to sustain the tensile loads that are imposed on the wire to keep them accurately located as the process proceeds. Because of their relatively low zinc content, beta phase coatings have been successfully applied to EDM wires, even though they are brittle enough that a full sectioned beta phase wire would be difficult to cold draw. Gamma phase coatings are even more brittle than beta phase coatings, and in point of fact, they are often so brittle that they produce discontinuous coatings where islands of gamma phase become embedded in the wire surface after being cold drawn. However even though the coating does not cover the full wire surface, the increased zinc content of the surface is enough that gamma phase coatings have been shown to outperform beta phase coatings. Conventionally processed, epsilon phase coatings are even more brittle than gamma phase. In addition to the brittleness limitation, epsilon phase is very unstable making it difficult to control the process of converting a zinc coating to epsilon phase in a manner similar to that used for converting a zinc coating to gamma phase.

The invention herein disclosed provides a process that allows the zinc to be converted to epsilon phase in a controlled manner thereby allowing the higher zinc content of the alloy phase coating to be taken advantage of. Furthermore by processing the wire at lower diffusion anneal temperatures than previously attempted, it has been discovered that zinc coatings can be converted to epsilon phase at very low temperatures where the epsilon phase is very stable. At these low temperatures, the process can be precisely controlled such that the metallurgical structure (and therefore the mechanical properties) of the wire is not modified.

The lower melting point of the epsilon phase is generally considered to be a disadvantage of epsilon phase coatings when compared to beta or gamma phase coatings. However, the higher zinc content of the epsilon phase has been found to offset that disadvantage such that epsilon phase coatings have been found to match the performance of beta phase coatings while being competitive with the performance of gamma phase coatings. Therefore, the epsilon phase coating provides similar cutting performance while having a lower cost to manufacture than either beta or gamma phase. Infiltrating the porous epsilon phase coating with graphite, e.g. by drawing the wire in a lubricant composed of a suspension of fine graphite particles in an aqueous medium, can further improve the performance of an epsilon phase coating.

In the following example, EDM wire was produced with a finish diameter of 0.25 mm and at a starting size and heat treatment as described.

### EXAMPLE 1

Core: 65Cu/35Zn; electroplated 10 μm of zinc at 0.9 mm diameter

Cold drawn from 0.9 mm to 0.25 mm

Annealing Temperature: 70° C.

Annealing Time: 20 hours (air cool)

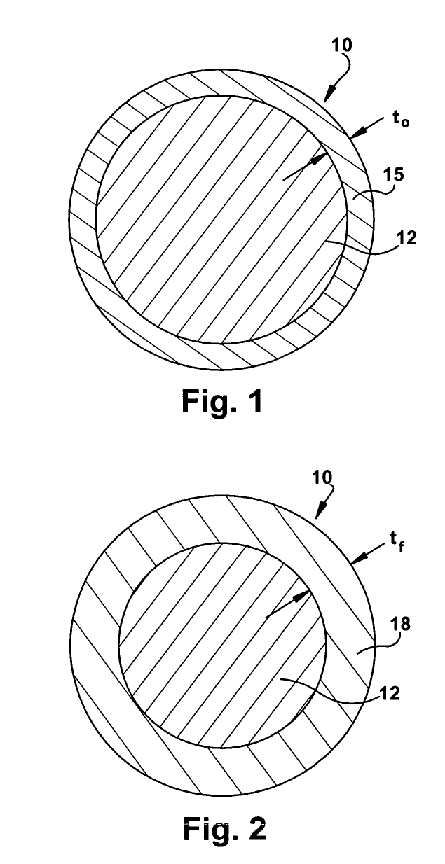

Referring to FIG. 1, a high brass core 12 is covered with a zinc coating 15 having an initial thickness (to) of 10 μm. After cold drawing and heat treatment, the wire is depicted in FIG. 2, with an epsilon phase brass coating 18 having a thickness tf that is equal to or greater than the initial thickness to. Since the zinc is not converted to epsilon phase until after the wire has been work hardened by cold deformation, the tensile strength of the wire electrode can be increased to a level suitable for EDM wire electrodes by cold drawing prior to heat treatment. By converting the zinc coating to epsilon phase at the finish diameter using a very low temperature for diffusion annealing (less than approximately 120C) it is possible to avoid altering the metallurgical structure of the core material or materials. Also, since the epsilon phase is not deformed by wire drawing, the coating remains intact and covers substantially all of the wire surface.

It is also believed that the ductility of the epsilon phase formed at such low temperatures is ductile enough to allow the heat treated wire to be drawn again to a finish diameter while maintaining a substantially continuous coating of epsilon phase, thereby further improving the effectiveness of the coating. The added drawing step may introduce some discontinuities in the coating.

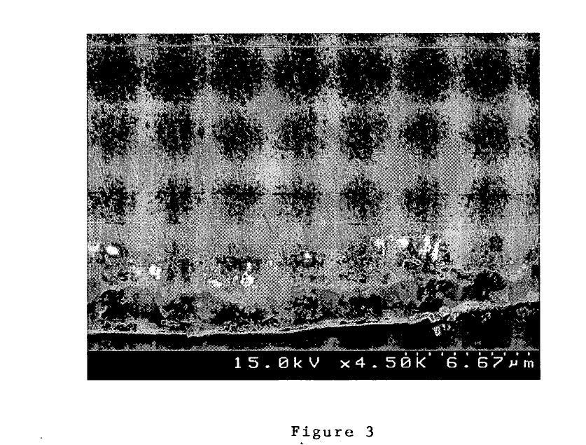

FIG. 3 illustrates a cross section view of the wire produced in Example 1 as examined in a Scanning Electron Microscope (SEM). Since the processing occurred at a relatively low temperature for a relatively long time (compared to the time to cool to room temperature), the sample can be considered to be processed under equilibrium conditions. Universally accepted equilibrium phase diagrams for the binary system copper/zinc, e.g. Constitution of Binary Alloys, by Hansen et al., pp. 649-655, 1958, will identify a 84Zn/16Cu alloy phase as epsilon phase brass.

As can be seen from the foregoing description, drawing a zinc coated, copper bearing core wire to its finish size and then heat treating the wire at very low temperature provides an EDM wire with a substantially continuous epsilon phase brass coating while maintaining the mechanical properties of the core wire. The coating resulting from the diffusion anneal may be porous, allowing it to be infiltrated with graphite to further enhance its discharge properties. The resulting EDM wire electrode can equal the cutting speed of beta phase coatings and remain competitive with the cutting speed of gamma phase coatings at a lower manufacturing cost than either of the other high zinc phase coatings. It is also believed that the epsilon coating is ductile enough to allow cold drawing of the heat treated wire while maintaining a substantially continuous or discontinuous coating of epsilon phase brass.

While this invention has been described as having a preferred design, the present invention can be further modified within the spirit and scope of this disclosure. The appended claims are therefore intended to cover any variations, uses, or adaptations of the invention using its general principles as well as any departures from the present disclosure as come within known or customary practice in the art to which this invention pertains and which fall within the limits of the appended claims.

What is claimed is:

1. An electrode wire for use in a electric discharge machining apparatus, said wire comprising:
a core comprising a copper bearing surface;
a coating disposed on said copper bearing surface; and
wherein said coating includes an alloy layer phase having greater than 80 percent zinc by weight.

2. The electrode wire of claim 1 wherein said coating is epsilon phase brass.

3. The electrode wire of claim 1 wherein said coating is a substantially continuous coating covering substantially an entirety of said copper bearing surface.

4. The electrode wire of claim 1 wherein said coating is discontinuous over said copper bearing surface.

5. The electrode wire of claim 1, wherein said core comprises brass.

6. The electrode wire of claim 5, wherein said brass comprises zinc in the range of 5% to 40%.

7. The electrode wire of claim 1, wherein said core comprises a beta phase stratified layer on an alpha phase brass substrate.

8. The electrode wire of claim 1, wherein said core comprises a beta phase stratified layer on a copper substrate.

9. The electrode wire of claim 1, wherein said core comprises a copper clad steel.

10. The electrode wire of claim 1, wherein said core comprises a beta phase stratified layer on a copper clad steel substrate.

11. The electrode wire of claim 1, wherein said coating has been infiltrated with graphite.

12. A process for manufacturing an electrical discharge machining electrical wire, said process comprising:
providing a copper bearing metal core wire;
coating said core wire with zinc;
heating said coated core at a temperature in the range of 50° C.-140° C. for a time period in the range of 3-50 hours until a coating of epsilon phase brass is formed; and
cooling said wire.

13. The process of claim 12 wherein said coated wire is drawn to a finish diameter prior to heating.

14. The process of claim 12 comprising drawing said cooled wire after heating to a finish diameter.
